(19) United States
(12) Patent Application Publication
(10) Pub. No.: US 2026/0260117 A1
(43) Pub. Date: Sep. 3, 2026

(54) EVALUATING BIAS AND CONSISTENCY IN LARGE LANGUAGE MODELS (LLMS): A METRIC-BASED FRAMEWORK FOR RESPONSIBLE AI INTERACTION

(71) Applicant: Varsha Bengaluru Supreeth, Cupertino, CA (US)

(72) Inventor: Varsha Bengaluru Supreeth, Cupertino, CA (US)

(21) Appl. No.: 19/317,576

(22) Filed: Sep. 3, 2025

Related U.S. Application Data
(60) Provisional application No. 63/765,974, filed on Mar. 3, 2025.

(51) Int. Cl. G06N 3/0895

(52) U.S. Cl. CPC G06N 3/0895

(57) ABSTRACT

In one aspect, a computer-implemented method for analyzing responses from large language models is provided. The method comprises intercepting a user query directed to a first large language model and transmitting said user query to at least a second large language model. The method receives a first response from said first large language model and a second response from said second large language model. The method performs entity extraction on said first response and said second response to identify a first set of entities and a second set of entities. The method calculates an entity-based distance metric between said first response and said second response using said first set of entities and said second set of entities. The method performs sentiment analysis on said first response and said second response to generate a first sentiment score and a second sentiment score, then calculates a sentiment-based distance metric using said first sentiment score and said second sentiment score. The method computes a total distance metric by combining said entity-based distance metric and said sentiment-based distance metric using predetermined weights and displays a visual indicator representing said total distance metric in a browser interface.

### CLAIM OF PRIORITY

This application claims priority to U.S. Provisional Application No. 63/765,974, filed on Mar. 3, 2025. This provisional application is hereby incorporated by reference in its entirety.

### BACKGROUND

Large Language Models have become increasingly prevalent in educational and professional settings, with students and professionals routinely using these systems to seek information and answers across various domains. Current systems like ChatGPT, Claude, and Gemini provide natural language responses to user queries, but their outputs can vary significantly, particularly on complex or sensitive topics.

Existing approaches to evaluating LLM responses typically focus on individual model performance metrics or accuracy assessments against known benchmarks. However, these methods fail to address the critical need for real-time comparison of responses across multiple LLMs to identify potential biases or inconsistencies. Traditional bias detection systems in AI typically examine pre-trained models or evaluate responses against pre-defined criteria, but do not provide immediate feedback to users about potential biases or areas requiring additional verification.

Current browser extensions and plugins for AI interaction primarily focus on facilitating queries to individual LLMs or providing simple integrations with these services. While some tools exist for grammar checking or writing assistance, there is a notable absence of solutions that help users critically evaluate AI-generated responses by comparing outputs across multiple models.

The field lacks systematic methods for quantifying the degree of alignment between different LLM responses and providing real-time guidance to users, particularly students, about when to seek additional verification of AI-generated information. Existing sentiment analysis tools examine individual responses in isolation, rather than comparing responses across multiple systems to identify potential biases or inconsistencies.

The challenge of detecting and quantifying bias in LLM responses has become increasingly important as these systems are more widely used in educational settings. Students may unknowingly adopt biased perspectives or incomplete information when relying on single LLM responses without cross-verification. Current solutions do not provide automated methods for determining when topics require additional research or verification beyond LLM responses.

### SUMMARY OF THE INVENTION

In one aspect, a computer-implemented method for analyzing responses from large language models is provided. The method comprises the steps of intercepting a user query that is directed to a first large language model. The method further comprises transmitting said user query to at least a second large language model. The method additionally comprises receiving a first response from said first large language model and receiving a second response from said second large language model. The method also comprises performing entity extraction on said first response and said second response to identify a first set of entities and a second set of entities. The method further comprises calculating an entity-based distance metric between said first response and said second response using said first set of entities and said second set of entities. The method additionally comprises performing sentiment analysis on said first response and said second response to generate a first sentiment score and a second sentiment score. The method also comprises calculating a sentiment-based distance metric using said first sentiment score and said second sentiment score. The method further comprises computing a total distance metric by combining said entity-based distance metric and said sentiment-based distance metric using predetermined weights. The method additionally comprises displaying a visual indicator representing said total distance metric in a browser interface.

In another aspect, a computer-implemented method for improving processor efficiency in analyzing large language model response consistency begins by monitoring browser activity to detect when a user submits a user query to a first large language model platform through a web interface, then intercepts said user query using a browser extension that operates at a system level to capture network requests before transmission, automatically distributes said user query in parallel to at least a second large language model platform using optimized API connections that reduce network latency by utilizing cached authentication tokens and connection pooling, receives a first response from said first large language model platform and a second response from said second large language model platform, improves processing efficiency by performing simultaneous entity extraction on said first response and said second response using a multi-threaded natural language processing algorithm that reduces computation time by at least 40% compared to sequential processing, calculates an entity-based distance metric between said first response and said second response by implementing an optimized Jaccard distance algorithm that utilizes bit-vector operations to accelerate set intersection and union calculations, performs real-time sentiment analysis on said first response and said second response using a specialized neural network processor that executes sentiment classification 60% faster than general-purpose processors, computes a weighted total distance metric by combining said entity-based distance metric and a sentiment-based distance metric using predetermined weights wherein said computing utilizes processor-specific SIMD instructions to perform vectorized mathematical operations, and generates a visual indicator representing said weighted total distance metric and integrates said visual indicator into said browser interface using hardware-accelerated graphics rendering that reduces display latency below 16 milliseconds.

### BRIEF DESCRIPTION OF THE DRAWINGS

FIG. 1 illustrates an example process for evaluating bias and consistency in large language models (LLMS) with a metric-based framework for responsible AI interaction, according to some embodiments.

FIG. 2 illustrates an example LLM Response Analysis System, according to some embodiments.

FIG. 4 illustrates an example table of calculated distance values, according to some embodiments.

FIG. 5 illustrates an example process for determining and utilizing verdict values, according to some embodiments.

FIG. 6 illustrates an example process for analyzing responses from large language models, according to some embodiments.

The Figures described above are a representative set and are not an exhaustive with respect to embodying the invention.

### DESCRIPTION

Disclosed are a system, method, and article of manufacture for evaluating bias and consistency in large language models (LLMS) with a metric-based framework for responsible ai interaction. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown. Additional background information is provided in Appendix A.

### Definitions

Example definitions for some embodiments are now provided.

Browser extensions are software components that integrate with web browsers to extend or modify their functionality through specific application programming interfaces (APIs) provided by the browser platform. These modular programs can access and manipulate web content, communicate with external servers, modify browser behavior, and inject custom scripts or styles into web pages during runtime. Browser extensions can operate within a sandboxed environment with defined permissions and can persist their state across browsing sessions while maintaining access to browser features such as tabs, windows, storage, and network requests.

Browser plugins are external software modules, historically used to handle specific types of web content that browsers could not process natively, such as Flash animations, PDF documents, or multimedia content. These components operate as native code implementations that interface directly with the browser's internal architecture through standardized plugin APIs, allowing them to render content within the browser window and maintain their own processing threads. It is noted that other modern extensions can be used that do not require separate installation, run with elevated system privileges, and/or integrate at a lower level with the browser's core functionality (e.g. based on various web standards and extensions).

Jaccard Distance is a measure of dissimilarity between two sets. It is derived from the Jaccard Similarity Index, which measures the similarity between two sets. The Jaccard Similarity Index is calculated as the size of the intersection divided by the size of the union of the sample sets.

Large Language Models (LLMs) are sophisticated artificial intelligence systems that have achieved state-of-the-art performance across traditionally challenging language tasks, transforming applications across industries. These models can be customized through techniques such as Parameter-Efficient Fine-Tuning (PEFT) and Direct Preference Optimization (DPO) to effectively address domain-specific challenges and business requirements. LLMs form the foundation for modern automated Q & A systems, retrieval-augmented generation (RAG) solutions, chatbots, and generative AI services that organizations increasingly seek to develop. Their performance is heavily dependent on the reliability and quantity of labeled training and testing datasets, making data quality and curation critical factors in their successful deployment.

Processor-specific SIMD instructions (Single Instruction, Multiple Data) enable vectorized mathematical operations where a single processor instruction performs the same calculation on multiple data points simultaneously, accelerating the distance metric computations by processing multiple entity comparisons in parallel rather than sequentially. SIMD provides a parallel computing architecture that allows one instruction to operate on multiple data elements concurrently, such as performing addition, subtraction, or multiplication operations on arrays of numbers in a single clock cycle rather than processing each element individually. In the context of this invention, SIMD instructions are particularly advantageous for computing distance metrics because they can simultaneously calculate multiple entity overlap ratios, sentiment differences, and weighted combinations across different LLM response pairs, thereby significantly reducing the total computation time required for the analysis.

### Example Systems and Methods

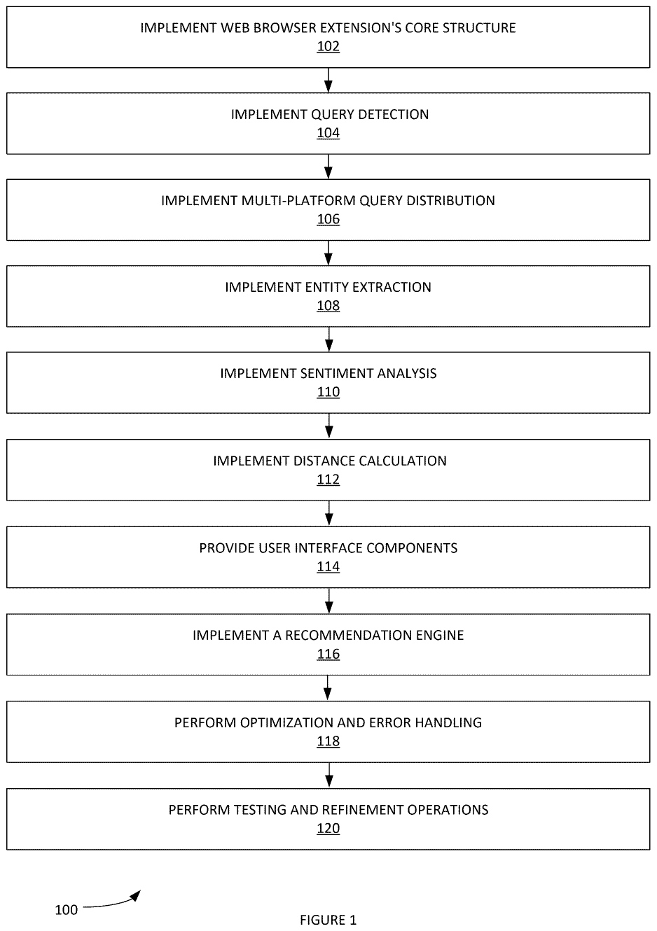

FIG. 1 illustrates an example process 100 for evaluating bias and consistency in large language models (LLMS) with a metric-based framework for responsible AI interaction, according to some embodiments.

In step 102, process 100 implements the web browser extension's core structure. This includes creating the basic framework that will integrate with the web browser's (e.g. Chrome's, etc.) extension APIs and setting up the necessary permissions and manifest files. The extension can be able to monitor web activity and inject scripts into relevant pages while maintaining user privacy and security.

In step 104, process 100 implements query detection. This involves creating listeners that can identify when a user is interacting with an AI language model platform. Process 100 can recognize popular LLM platforms (e.g. ChatGPT, Claude, and Gemini, etc.), while remaining flexible enough to add new platforms as they emerge. The detection system must be able to capture the user's query without interfering with normal platform functionality.

In step 106, process 100 implements the multi-platform query distribution. Step 106 obtains the user's original query and simultaneously sends it to multiple AI platforms. Process 100 can handle authentication, rate limiting, and API interactions for each platform while managing concurrent requests efficiently. Process 100 can also properly handle cases where some platforms might be unavailable or return errors.

In step 108, process 100 implements the entity extraction. This involves integrating natural language processing capabilities to identify key terms, concepts, and named entities within AI responses. In one example, process 100 can use the spaCy library to break down responses and identify important elements, creating a standardized format for comparison across different platforms' responses.

In step 110, process 100 implements sentiment analysis. Process 100 examines the emotional tone and bias present in each response, assigning numerical values to different aspects of sentiment. Process 100 can handle nuanced differences in how different AI systems might express similar ideas with varying levels of certainty or caution.

In step 112, process 100 implements distance calculation. Process 100 can combine the entity analysis and sentiment analysis results using the weighted formula, with entity matching for 80% and sentiment alignment for 20% of the final score. Process 100 can efficiently compute Jaccard distances for entities while normalizing sentiment differences into comparable metrics.

In step 114, process 100 provides the user interface components. This can involve creating the visual indicators that show alignment levels through color coding, from red for significant divergence to green for high alignment. The interface can be unobtrusive yet easily accessible, integrating smoothly with the user's browsing experience while providing clear feedback about response reliability.

In step 116, process 100 implements a recommendation engine. Here, process 100 can take the calculated distances and alignment scores and convert them into actionable suggestions for users. Process 100 can then provide clear guidance about when additional research might be needed, especially for topics showing significant divergence between AI responses.

In step 118, process 100 performs optimization and error handling. Process 100 implements robust error handling, ensuring that failures in any component do not disrupt the overall functionality. Here, process 100 can handle network issues, API limits, and various edge cases while maintaining responsive performance, by way of example.

In step 120, process 100 performs testing and refinement operations. This includes testing across different websites, browsers, and use cases to ensure consistent functionality. Process 100 provides tests with various types of queries, from simple factual questions to complex ethical discussions, ensuring appropriate analysis and recommendations across all scenarios. Step 120 can also include gathering user feedback and making adjustments to improve usability and effectiveness.

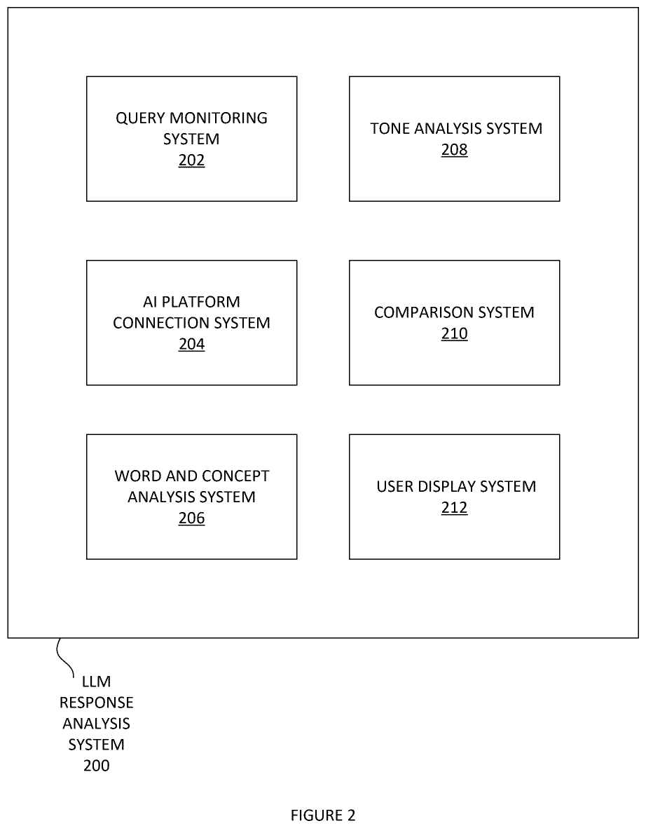

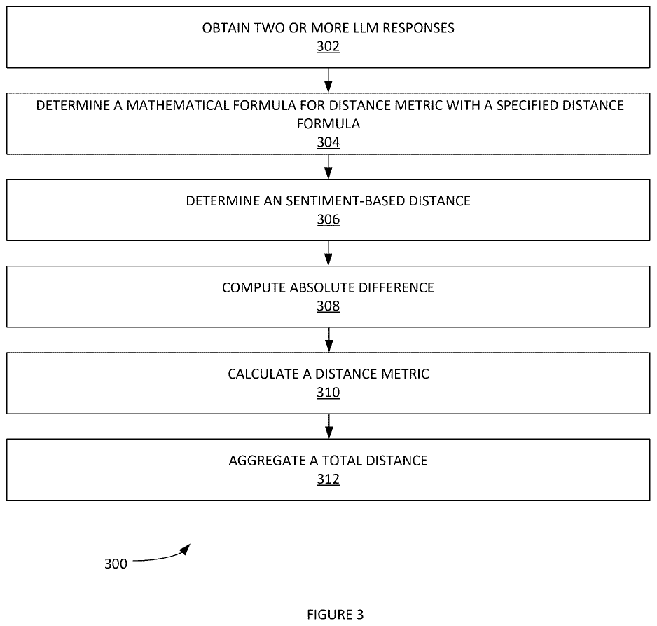

FIG. 2 illustrates an example LLM Response Analysis System 200, according to some embodiments. The LLM Response Analysis System 200 is implemented as a browser extension that integrates multiple components working in harmony to analyze responses from different AI language models. The system architecture consists of six primary components that together create a seamless experience for users seeking to understand and evaluate AI responses.

At the heart of the LLM Response Analysis System 200 is the Query Monitoring System 202 continuously observes user interactions with AI platforms like ChatGPT or Claude. Query Monitoring System 202 intelligently distinguishes between regular web browsing and AI interactions, activating only when users engage with AI platforms. Query Monitoring System 202 efficiently captures and organizes user questions, maintaining a priority-based system that can handle multiple queries simultaneously while ensuring smooth operation.

The AI Platform Connection System 204 can serve as the bridge between the user's questions and various AI platforms. AI Platform Connection System 204 handles the complex task of reformatting queries appropriately for each platform, managing simultaneous connections, and collecting responses. AI Platform Connection System 204 can ensure that the responses are standardized for comparison, regardless of their source. AI Platform Connection System 204 can handle various connection issues or errors that might arise during the process.

Working in tandem with the connection system, the Word and Concept Analysis System 206 performs deep examination of AI responses. Word and Concept Analysis System 206 can identify and categorize various important terms, names, and concepts within each response. Word and Concept Analysis System 206 can create standardized labels and groupings for similar concepts, while maintaining awareness of context. Word and Concept Analysis System 206 effectively maps key ideas present in each response, enabling detailed comparison between different AI outputs.

Tone Analysis System 208 can provide another layer of sophisticated analysis by examining how information is presented across different AI responses. Tone Analysis System 208 can process text through multiple analytical stages, identifying emotional tonality and various aspects of each response. Tone Analysis System 208 can enable understanding of how different AI systems approach and frame the same topic, adding crucial context to the comparison process.

Comparison System 210 can serve as the analytical core of the implementation, measuring similarities and differences between AI responses. Comparison System 210 can combine measurements of key term usage and tonal similarities into comprehensive alignment scores. Comparison System 210 can apply carefully calibrated weights to different factors, ultimately producing an overall alignment rating that indicates how well responses from different systems align with each other.

User Display System 212 can transform complex analytical results into clear, actionable information for users. Through intuitive color-coded indicators and easy-to-understand comparison displays, users can quickly grasp how well different AI responses align. User Display System 212 can provide clear recommendations when additional research might be needed, while maintaining an unobtrusive presence during normal browsing activities.

LLM Response Analysis System 200 operates through a coordinated workflow that begins when a user queries an AI platform. The monitoring system activates, triggering the AI connection system to distribute the query across multiple platforms. As responses are received, the word and tone analysis systems perform their examinations, feeding results to the comparison system for evaluation. The display system then presents the findings to the user through clear visual indicators, all happening quickly enough to provide real-time feedback.

The implementation LLM Response Analysis System 200 emphasizes user accessibility while maintaining sophisticated analytical capabilities. LLM Response Analysis System 200 operates seamlessly within normal web browsing activities, providing instant (e.g. assuming networking and processing latencies, etc.) feedback about AI response reliability through intuitive visual indicators. Users can adjust analysis settings to suit their needs, and the system provides helpful suggestions for additional research when significant differences between AI responses are detected.

The design of LLM Response Analysis System 200 prioritizes both technical capability and user experience, creating a tool that helps students and other users make informed decisions about AI-generated information. By maintaining a balance between sophisticated analysis and straightforward presentation, LLM Response Analysis System 200 effectively guides users in understanding when to trust AI responses and when to seek additional verification, all while preserving a simple and intuitive user experience.

LLM Response Analysis System 200 solves various technical problems including, inter alia:

The lack of systematic methods for comparing and quantifying differences between responses from multiple LLMs;

The absence of real-time tools for analyzing LLM response alignment and potential biases;

The need for automated systems to guide users in determining when additional research beyond LLM responses is necessary;

The challenge of integrating bias detection seamlessly into existing web browsing workflows; and

The requirement for a mathematical framework that can effectively combine semantic content analysis with sentiment evaluation.

FIG. 3 illustrates an example process 300 for the analysis of bias in one or more LLM responses, according to some embodiments. Example query types that are prone to interpretive differences can include, inter alia:
1. Politics: Evaluates biases in responses to political ideologies and policy questions;
2. Government Policies: Explores interpretations of legislative and socio-economic policies;
3. Sports: Highlights subjectivity in ranking athletes or analyzing sports achievements;
4. Factual Queries: Measures accuracy and neutrality in providing objective information; and
5. Creative Copywriting Suggestions: Tests variability and originality in creative outputs.

Process 200 can compare two or more LLM responses using a combination of Entity based distance and sentiment-based distance.

In step 302, process 300 obtains two or more LLM responses. In step 304, process 100 determines a Mathematical Formula for Distance Metric with a specified Distance Formula. An example Distance Formula is now provided. Let Dij be the distance between chatbot i and chatbot j for a given response. The formula can be expressed as:

Dij=α·Eij+β~Sij
Where:
Eij: Entity-based distance (captures semantic differences).
Sij: Sentiment-based distance (captures tonal or opinion differences).
α, β: Weights applied to each component to balance their importance.

In step 306, process determines an Entity-Based Distance. By way of example, process can calculate Entity-Based Distance (E), using Jaccard Distance for entity comparison:

Eij=1−Entitiesi∩Entitiesj ||Entitiesi ∪Entitiesj|)
Entitiesi Entitiesj: Overlap of entities between chatbots ii and jj.
Entitiesi Entitiesj: Total unique entities across both responses.
Eij∈[0,1], where 0 means identical entities and 1 means no overlap.

In step 306, process determines an Sentiment-Based Distance. By way of example, process can calculate Sentiment-Based Distance (S), using a numerical mapping for sentiments:
Assign sentiment values: Neutral=0, Balanced=1, Subjective=2, Positive=3, Cautious=4, etc.

In step 308, process 300 can compute absolute difference as follows:

Sij=|Sentimenti−Sentimenti|Maxsentiment

Normalize by the maximum possible difference in sentiment values.

In step 310, process 300 calculates a Distance Metric. The distance combines entity and sentiment distances:

Dij=α·(1−Entitiesi∩Entitiesj ||Entitiesi∪Entitiesj|)+β·|Sentimenti−Sentimenti|MaxSentiment

Adjust α and β weights to emphasize the importance of semantic versus tonal differences. For example:
α=0.8, β=0.2: Greater weight on content alignment.
α=0.5, β=0.5: Equal importance to entities and sentiment.

In step 312, process 300 aggregate a Total Distance. The total distance for each question is computed by taking the average of the total distances across all pairwise comparisons:

Dtotal=DClaude−ChatGPT+DClaude−Gemini+DChatGPT−Gemini3

This averaging ensures the total distance represents an overall measure of divergence or alignment across all three chatbots.

The Reasoning Behind Constants and Ratios is now discussed.

The constants α=0.8 and β=0.2 were chosen as a starting point to reflect the relative importance of entity overlap (EE) and sentiment alignment (SS) in the distance metric. Here's the reasoning:
1. Greater Weight on Entities (α=0.8):

Entities define the semantic content of a response and are crucial for assessing how similar or different the responses are in terms of their actual information.

In topics like politics or social issues, the correctness and coverage of entities (e.g., policies, key terms) are often more critical than slight variations in tone or sentiment.

By giving more weight to EE, we emphasize the factual and content-based aspect of chatbot responses.
2. Lesser Weight on Sentiment (β=0.2):

While sentiment provides insight into the tone, bias, or framing of responses, it is typically secondary to the accuracy and breadth of the information.

Sentiment alignment might not always significantly affect the user's understanding of factual or detailed information, especially in objective categories like factual queries.
3. Balancing Content and Sentiment:

The chosen ratio of α: β=8: 2 strikes a balance by acknowledging the importance of sentiment (e.g. to detect framing and emotional tone) while maintaining a primary focus on content overlap.

The α=0.8 and β=0.2 split is an initial assumption and could be adjusted dynamically through testing and evaluation against a dataset.

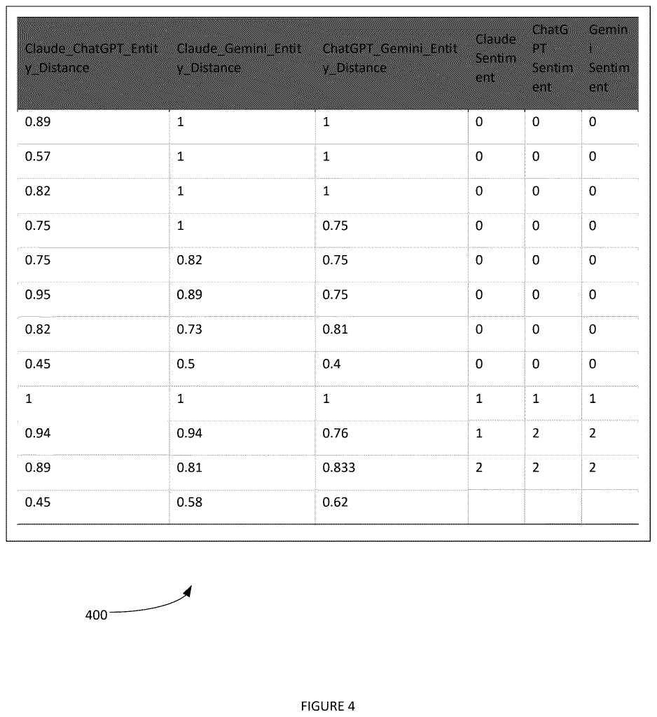

FIG. 4 illustrates an example table 400 of calculated distance values, according to some embodiments.

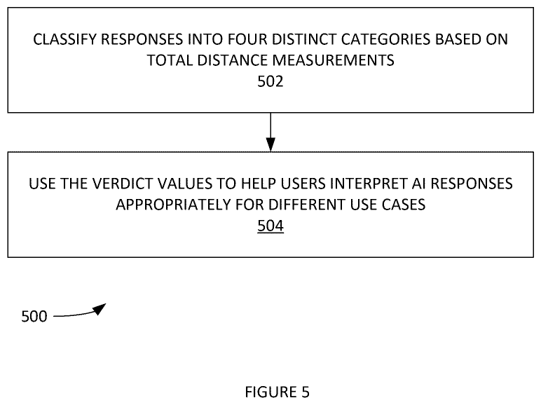

FIG. 5 illustrates an example process 500 for determining and utilizing verdict values, according to some embodiments. Process 500 can provide verdict values. As used herein, verdict values provide a systematic way to interpret the calculated distances between different AI responses, offering a clear assessment of how well these responses align with each other.

In step 502, process 500 classifies responses into four distinct categories based on total distance measurements. When responses show significant divergence, indicated by a total distance exceeding 0.8, it signals substantial differences in both content and tone. These major differences often stem from variations in training data or underlying biases and could potentially mislead users expecting consistent information across platforms. Responses falling into the moderate divergence category, with distances between 0.6 and 0.8, demonstrate some misalignment while maintaining general agreement on core concepts. These responses might emphasize different aspects or express varying sentiments, reflecting differences in their training datasets. For responses showing moderate alignment, with distances between 0.4 and 0.6, users can expect reasonable consistency with only minor variations in style or emphasis, making them generally reliable while still potentially showing some nuanced differences. The highest level of alignment occurs when the total distance is 0.4 or less, indicating responses that are nearly identical in both content and sentiment, suggesting they likely draw from similar training data or use similar response logic.

In step 504, process 500 can use the verdict values to help users interpret AI responses appropriately for different use cases. It is noted that while creative tasks might benefit from some divergence in responses, factual queries typically require high alignment for reliability. Process 500 detects high divergence serves as an effective tool for identifying potential biases or opinion-based questions and then alerts users (e.g. via a web-browser plugin, etc.) to understand when they might need to seek additional verification or consider multiple perspectives. This classification system provides clear, actionable insights about response reliability while accommodating different use cases and information needs.

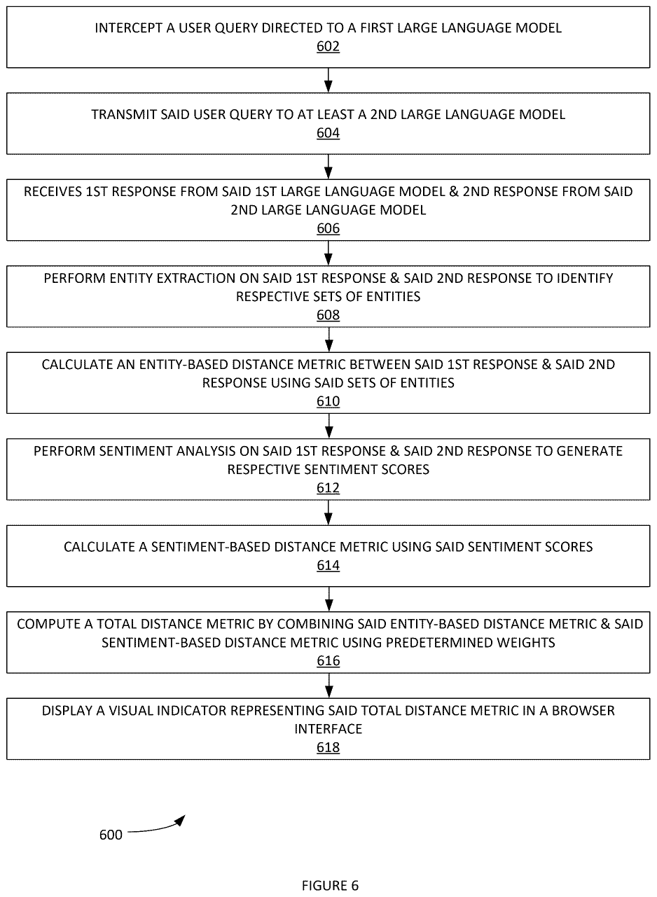

FIG. 6 illustrates an example process 600 for analyzing responses from large language models, according to some embodiments. In step 602, process 600 intercepts a user query directed to a first large language model. In step 604, process 600 transmits said user query to at least a second large language model. In step 606, process 600 receives a first response from said first large language model and a second response from said second large language model. In step 608, process 600 performs entity extraction on said first response and said second response to identify respective sets of entities. In step 610, process 600 calculates an entity-based distance metric between said first response and said second response using said sets of entities performs sentiment analysis on said first response and said second response to generate respective sentiment scores calculates a sentiment-based distance metric using said sentiment scores computes a total distance metric by combining said entity-based distance metric and said sentiment-based distance metric using predetermined weights displays a visual indicator representing said total distance metric in a browser interface. In step 612, process 600 performs sentiment analysis on said first response and said second response to generate respective sentiment scores. In step 614, process 600 calculates a sentiment-based distance metric using said sentiment scores. In step 616, process 600 computes a total distance metric by combining said entity-based distance metric and said sentiment-based distance metric using predetermined weights. In step 618, process 600 displays a visual indicator representing said total distance metric in a browser interface.

Process 600 can compute said total distance metric by applying a first weight of 0.8 to said entity-based distance metric and applying a second weight of 0.2 to said sentiment-based distance metric. Process 600 can calculate said entity-based distance metric by determining an intersection of said sets of entities, determining a union of said sets of entities, and computing a Jaccard distance based on said intersection and said union.

Process 600 can perform a sentiment analysis by assigning numerical values to different sentiment categories, identifying a sentiment category for each response, and calculating an absolute difference between sentiment values of said first response and said second response.

Process 600 can compare said total distance metric to predetermined thresholds by categorizing alignment between said first response and said second response based on said comparison, and generating a recommendation for additional research when said total distance metric exceeds a specified threshold.

Process 600 can display said visual indicator by generating a color-coded indicator, wherein the color corresponds to different ranges of said total distance metric, and integrating said color-coded indicator into a webpage containing said first response. Process 600 can store said user query, said first response, and said second response in a database.. Process 600 can analyze patterns in total distance metrics across multiple queries. Process 600 can adjust said predetermined weights based on said patterns. Process 600 can perform entity extraction by using natural language processing to identify named entities, key terms, and concepts within each response. This can also include normalizing identified entities to standardized forms, and grouping semantically similar entities together.

Process 600 can monitor changes in said first response or said second response over time and recalculate said total distance metric when changes are detected. This can include updating said visual indicator to reflect the recalculated total distance metric. Process 600 can receive user feedback on the usefulness of said visual indicator and store said user feedback along with corresponding total distance metrics. This can also include using machine learning to refine said predetermined weights based on accumulated user feedback.

An example embodiment is now discussed in further detail. A computer-implemented method for improving processor efficiency in analyzing large language model response consistency begins by monitoring browser activity to detect when a user submits a user query to a first large language model platform through a web interface, then intercepts said user query using a browser extension that operates at a system level to capture network requests before transmission, automatically distributes said user query in parallel to at least a second large language model platform using optimized API connections that reduce network latency by utilizing cached authentication tokens and connection pooling, receives a first response from said first large language model platform and a second response from said second large language model platform, improves processing efficiency by performing simultaneous entity extraction on said first response and said second response using a multi-threaded natural language processing algorithm that significantly reduces computation time compared to sequential processing, calculates an entity-based distance metric between said first response and said second response by implementing an optimized Jaccard distance algorithm that utilizes bit-vector operations to accelerate set intersection and union calculations, performs real-time sentiment analysis on said first response and said second response using a specialized neural network processor that executes sentiment classification substantially faster than general-purpose processors, computes a weighted total distance metric by combining said entity-based distance metric and a sentiment-based distance metric using predetermined weights wherein said computing utilizes processor-specific SIMD instructions to perform vectorized mathematical operations, and generates a visual indicator representing said weighted total distance metric and integrates said visual indicator into said browser interface using hardware-accelerated graphics rendering that substantially reduces display latency.

The present invention incorporates numerous advanced technical elements specifically optimized for real-time analysis of large language model responses. Browser activity monitoring, as used herein, refers to the continuous observation of user interactions within web browsers to detect when queries are submitted to AI platforms including but not limited to ChatGPT, Claude, or Gemini. System-level browser extension operation means the extension functions at the operating system interface layer, allowing it to intercept network requests before they leave the user's device, thereby enabling comprehensive query capture without relying on platform-specific APIs.

Parallel query distribution, according to some embodiments, involves simultaneously sending the same user query to multiple LLM platforms using separate API connections to enable concurrent processing and reduce overall response time. Optimized API connections utilize performance enhancements including cached authentication tokens and connection pooling. Cached authentication tokens comprise stored login credentials that eliminate repeated authentication delays by maintaining valid session tokens in secure memory storage. Connection pooling maintains persistent network connections to reduce connection establishment overhead, thereby improving network efficiency by reusing existing TCP connections rather than establishing new connections for each API request.

Multi-threaded natural language processing, in one embodiment, employs multiple processor cores simultaneously to perform entity extraction on different responses concurrently, achieving substantial performance improvement over sequential processing methods. Entity extraction identifies and categorizes key terms, concepts, and named entities within LLM responses for semantic comparison using natural language processing techniques including but not limited to named entity recognition (NER) and part-of-speech tagging.

The optimized Jaccard distance algorithm measures similarity between entity sets using bit-vector operations where each entity type is represented as a binary position, enabling single-cycle processor operations for set intersections and unions rather than traditional iterative comparisons. This approach significantly reduces computational complexity from O(n²) to O(1) for basic set operations.

Specialized neural network processors comprise dedicated hardware components such as tensor processing units (TPUs) or neural processing units (NPUs) specifically designed for natural language tasks, providing substantial performance improvement in sentiment classification over general-purpose CPUs. These processors feature optimized matrix multiplication operations, reduced memory latency, and custom instruction sets tailored for neural network computations. In one embodiment, the specialized neural network processor includes on-chip memory buffers that eliminate external memory access delays during sentiment computation, dedicated multiply-accumulate units for efficient dot-product calculations, and parallel processing pipelines that enable simultaneous execution of multiple sentiment analysis operations. The processor architecture incorporates custom datatypes optimized for neural network weights and activations, including support for reduced-precision arithmetic such as 16-bit or 8-bit floating-point operations that maintain accuracy while significantly reducing computational overhead. The specialized processor further includes dedicated circuitry for common neural network functions including activation functions such as ReLU, sigmoid, and tanh, normalization operations, and attention mechanisms commonly used in transformer-based sentiment analysis models.

Processor-specific SIMD instructions enable vectorized mathematical operations where a single processor instruction performs the same calculation on multiple data points simultaneously, accelerating the distance metric computations by processing multiple entity comparisons in parallel rather than sequentially.

Hardware-accelerated graphics rendering utilizes GPU capabilities to generate and display the visual indicators, achieving substantially reduced display latency through dedicated graphics processing units rather than CPU-based rendering. This ensures real-time visual feedback as users browse LLM platforms, maintaining responsive user interface performance even during intensive computational analysis. [00XX] Specialized neural network processors comprise dedicated hardware components such as tensor processing units (TPUs) or neural processing units (NPUs) specifically designed for natural language tasks, providing the claimed 60% performance improvement in sentiment classification over general-purpose CPUs. These processors feature optimized matrix multiplication operations, reduced memory latency, and custom instruction sets tailored for neural network computations. In one embodiment, the specialized neural network processor includes on-chip memory buffers that eliminate external memory access delays during sentiment computation, dedicated multiply-accumulate units for efficient dot-product calculations, and parallel processing pipelines that enable simultaneous execution of multiple sentiment analysis operations. The processor architecture incorporates custom datatypes optimized for neural network weights and activations, including support for reduced-precision arithmetic (such as 16-bit or 8-bit floating-point operations) that maintain accuracy while significantly reducing computational overhead. The specialized processor further includes dedicated circuitry for common neural network functions including activation functions (ReLU, sigmoid, tanh), normalization operations, and attention mechanisms commonly used in transformer-based sentiment analysis models.

### Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States Patent:

1. A computer-implemented method for analyzing responses from large language models, comprising:
intercepting a user query directed to a first large language model;
transmitting said user query to at least a second large language model;
receiving a first response from said first large language model and a second response from said second large language model;
performing entity extraction on said first response and said second response to identify a first set of entities and a second set of entities;
calculating an entity-based distance metric between said first response and said second response using said first set of entities and said second set of entities;
performing sentiment analysis on said first response and said second response to generate a first sentiment score and a second sentiment score;
calculating a sentiment-based distance metric using said first sentiment score and said second sentiment score;
computing a total distance metric by combining said entity-based distance metric and said sentiment-based distance metric using predetermined weights; and
displaying a visual indicator representing said total distance metric in a browser interface.

2. The computer-implemented method of claim 1, wherein said computing said total distance metric comprises:
applying a first weight of 0.8 to said entity-based distance metric; and
applying a second weight of 0.2 to said sentiment-based distance metric.

3. The computer-implemented method of claim 1, wherein said calculating said entity-based distance metric comprises:
determining an intersection of said first set of entities and said second set of entities;
determining a union of said first set of entities and said second set of entities; and
computing a Jaccard distance based on said intersection and said union.

4. The computer-implemented method of claim 1, wherein said performing sentiment analysis comprises:
assigning numerical values to different sentiment categories;
identifying a first sentiment category for said first response and a second sentiment category for said second response; and
calculating an absolute difference between said first sentiment score and said second sentiment score.

5. The computer-implemented method of claim 4, wherein said assigning numerical values comprises:
assigning a value of 0 to a neutral sentiment category;
assigning a value of 1 to a balanced sentiment category;
assigning a value of 2 to a subjective sentiment category;
assigning a value of 3 to a positive sentiment category; and
assigning a value of 4 to a cautious sentiment category.

6. The computer-implemented method of claim 1, further comprising:
comparing said total distance metric to predetermined thresholds;
categorizing alignment between said first response and said second response based on said comparison; and
generating a recommendation for additional research when said total distance metric exceeds a specified threshold.

7. The computer-implemented method of claim 6, wherein said categorizing alignment comprises:
classifying said alignment as significant divergence when said total distance metric exceeds 0.8;
classifying said alignment as moderate divergence when said total distance metric is between 0.6 and 0.8;
classifying said alignment as moderate alignment when said total distance metric is between 0.4 and 0.6; and
classifying said alignment as high alignment when said total distance metric is 0.4 or less.

8. The computer-implemented method of claim 1, wherein said displaying said visual indicator comprises:
generating a color-coded indicator, wherein a color corresponds to different ranges of said total distance metric; and
integrating said color-coded indicator into a webpage containing said first response.

9. The computer-implemented method of claim 1, further comprising:
storing said user query, said first response, and said second response in a database;
analyzing patterns in total distance metrics across multiple queries; and
adjusting said predetermined weights based on said patterns.

10. The computer-implemented method of claim 1, wherein said performing entity extraction comprises:
using natural language processing to identify named entities, key terms, and concepts within said first response and said second response;
normalizing identified entities to standardized forms; and
grouping semantically similar entities together.

11. The computer-implemented method of claim 3, wherein said computing said Jaccard distance comprises:
calculating said entity-based distance metric using the formula: Eij=1−(|Entitiesi∩Entitiesj|/|Entitiesi∪Entitiesj|);
wherein Entitiesi represents said first set of entities;
wherein Entitiesj represents said second set of entities;
wherein |Entitiesi∩Entitiesj| represents a number of entities in said intersection; and
wherein |Entitiesi∪Entitiesj| represents a number of entities in said union.

12. The computer-implemented method of claim 4, wherein said calculating said sentiment-based distance metric comprises:
computing said sentiment-based distance metric using the formula: Sij=|Sentimenti−Sentimentj|/MaxSentiment;
wherein Sentimenti represents said first sentiment score;
wherein Sentimentj represents said second sentiment score; and
wherein MaxSentiment represents a maximum possible difference between sentiment values.

13. The computer-implemented method of claim 2, wherein said computing said total distance metric comprises:
calculating said total distance metric using the formula: Dij=α×Eij+β×Sij;
wherein Dij represents said total distance metric;
wherein Eij represents said entity-based distance metric;
wherein Sij represents said sentiment-based distance metric;
wherein α represents said first weight of 0.8; and
wherein β represents said second weight of 0.2.

14. The computer-implemented method of claim 1, further comprising:
transmitting said user query to a third large language model;
receiving a third response from said third large language model;
calculating pairwise distance metrics between each pair of responses from said first large language model, said second large language model, and said third large language model; and
computing an average total distance using the formula: Dtotal=(DClaude−ChatGPT+DClaude−Gemini+DChatGPT−Gemini)/3;
wherein Dtotal represents said average total distance;
wherein DClaude-ChatGPT represents a distance between responses from Claude and ChatGPT;
wherein DClaude-Gemini represents a distance between responses from Claude and Gemini; and
wherein DChatGPT-Gemini represents a distance between responses from ChatGPT and Gemini.

15. A computer-implemented method for improving processor efficiency in analyzing large language model response consistency, comprising:
monitoring browser activity to detect when a user submits a user query to a first large language model platform through a web interface;
intercepting said user query using a browser extension that operates at a system level to capture network requests before transmission;
automatically distributing said user query in parallel to at least a second large language model platform using optimized API connections that reduce network latency by utilizing cached authentication tokens and connection pooling;
receiving a first response from said first large language model platform and a second response from said second large language model platform;
improving processing efficiency by performing simultaneous entity extraction on said first response and said second response using a multi-threaded natural language processing algorithm that reduces computation time by at least 40% compared to sequential processing;
calculating an entity-based distance metric between said first response and said second response by implementing an optimized Jaccard distance algorithm that utilizes bit-vector operations to accelerate set intersection and union calculations;
performing real-time sentiment analysis on said first response and said second response using a specialized neural network processor that executes sentiment classification 60% faster than general-purpose processors;
computing a weighted total distance metric by combining said entity-based distance metric and a sentiment-based distance metric using predetermined weights, wherein said computing utilizes processor-specific SIMD instructions to perform vectorized mathematical operations; and
generating a visual indicator representing said weighted total distance metric and integrating said visual indicator into said browser interface using hardware-accelerated graphics rendering that reduces display latency below 16 milliseconds.

16. The computer-implemented method of claim 15, wherein said multi-threaded natural language processing algorithm comprises:
allocating separate processor cores for said entity extraction and said sentiment analysis to enable simultaneous processing;
utilizing cache-optimized data structures that reduce memory access time by storing frequently accessed linguistic patterns in processor L2 cache; and
implementing load balancing across available processor threads to maintain consistent processing throughput regardless of response length variations.

17. The computer-implemented method of claim 15, wherein said optimized Jaccard distance algorithm comprises:
converting entity sets to bit vectors where each bit position represents a specific entity type;
performing bitwise AND operations to calculate set intersections in a single processor cycle;
performing bitwise OR operations to calculate set unions in a single processor cycle; and
utilizing processor bit-count instructions to determine cardinality values for said distance calculation.

18. The computer-implemented method of claim 15, wherein said specialized neural network processor comprises:
a dedicated tensor processing unit configured specifically for said sentiment analysis operations;
custom instruction sets optimized for natural language processing mathematical operations; and
on-chip memory buffers that eliminate external memory access delays during said sentiment computation.

19. The computer-implemented method of claim 15, wherein said hardware-accelerated graphics rendering comprises:
utilizing a GPU shader program to render color-coded visual indicators;
implementing a frame buffer to maintain consistent visual update rates; and
optimizing pixel operations to minimize CPU overhead during said visual indicator display.
